(19) United States
(12) Patent Application Publication
(10) Pub. No.: US 2026/0226634 A1
(43) Pub. Date: Aug. 6, 2026

(54) MEMBRANE ELECTRODE ASSEMBLY AND ELECTROCHEMICAL REACTION DEVICE

(71) Applicants: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(72) Inventors: Norihiro YOSHINAGA, Yokohama Kanagawa (JP); Akihiko ONO, Kita Tokyo (JP); Yoshitsune SUGANO, Kawasaki Kanagawa (JP); Taishi FUKAZAWA, Chofu Tokyo (JP)

(73) Assignees: KABUSHIKI KAISHA TOSHIBA, Kawasaki-shi Kanagawa (JP); TOSHIBA ENERGY SYSTEMS & SOLUTIONS CORPORATION, Kawasaki-shi Kanagawa (JP)

(21) Appl. No.: 19/455,212

(22) Filed: Jan. 21, 2026

(30) Foreign Application Priority Data
Jan. 31, 2025 (JP) 2025-014938

(51) Int. Cl. C25B 9/23; C25B 1/04; C25B 11/093; C25B 11/095

(52) U.S. Cl. CPC C25B 9/23; C25B 11/093; C25B 11/095; C25B 1/04

(57) ABSTRACT

A membrane electrode assembly includes an anode having an anode catalyst layer, a cathode having a cathode catalyst layer, and an electrolyte membrane provided between the anode and the cathode. An ion exchange equivalent weight of the electrolyte membrane is equal to or higher than an ion exchange equivalent weight of the cathode catalyst layer. An ion exchange equivalent weight of the anode catalyst layer is higher than the ion exchange equivalent weight of the cathode catalyst layer and is equal to or higher than the ion exchange equivalent weight of the electrolyte membrane.

### CROSS-REFERENCE TO RELATED APPLICATIONS

This application is based upon and claims the benefit of priority from Japanese Patent Application No. 2025-14938, filed on Jan. 31, 2025; the entire contents of which are incorporated herein by reference.

### FIELD

Embodiments of the present invention relate to a membrane electrode assembly and an electrochemical reaction device.

### BACKGROUND

The development of electrochemical reaction devices, such as a water electrolysis device (also called a hydrogen production device) that converts water or oxygen into hydrogen, has recently been underway. The water electrolysis device includes, for example, a membrane electrode assembly (MEA) having an anode, a cathode, and an electrolyte membrane. For example, the water electrolysis device oxidizes water to produce hydrogen ions and oxygen in the anode, and reduces the hydrogen ions to produce hydrogen in the cathode.

### BRIEF DESCRIPTION OF THE DRAWINGS

FIG. 1 is a schematic view illustrating an example of a membrane electrode assembly.

FIG. 2 is a schematic sectional view illustrating a structure example of an electrode 10.

FIG. 3 is a schematic sectional view illustrating a structure example of an electrode 20.

FIG. 4 is a schematic sectional view illustrating a structure example of an electrolyte membrane 30.

FIG. 5 is a schematic view illustrating a sectional structure of part of a stacked structure.

FIG. 6 is a schematic sectional view for explaining an example of a method of forming a catalyst layer.

FIG. 7 is a schematic view illustrating a configuration example of an electrochemical reaction device.

### DETAILED DESCRIPTION

A membrane electrode assembly of an embodiment includes an anode having an anode catalyst layer, a cathode having a cathode catalyst layer, and an electrolyte membrane provided between the anode and the cathode. An ion exchange equivalent weight of the electrolyte membrane is equal to or higher than an ion exchange equivalent weight of the cathode catalyst layer. An ion exchange equivalent weight of the anode catalyst layer is higher than the ion exchange equivalent weight of the cathode catalyst layer and is equal to or higher than the ion exchange equivalent weight of the electrolyte membrane.

Embodiments will be hereinafter described with reference to the drawings. In the following embodiments, substantially the same constituent parts are denoted by the same reference signs, and a description thereof may be partly omitted. The drawings are schematic, and the relationship between thickness and planar dimensions, a thickness ratio among the parts, and so on may be different from the actual ones.

It should be noted that, in the present specification, “connect” includes not only direct connection but also indirect connection unless otherwise specified.

### First Embodiment

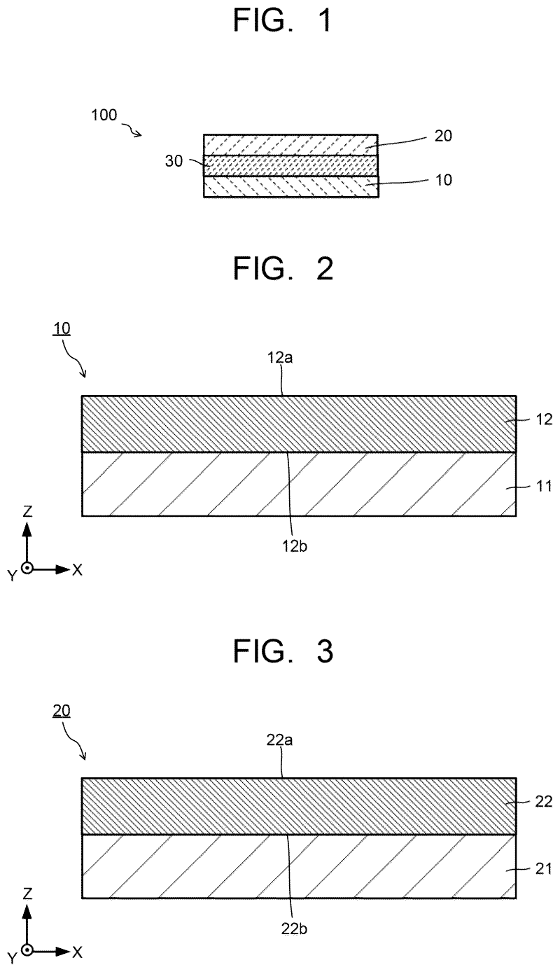

In this embodiment, an example of a membrane electrode assembly will be described. FIG. 1 is a schematic view illustrating a configuration example of the membrane electrode assembly. FIG. 1 illustrates the membrane electrode assembly 100.

The membrane electrode assembly 100 has an electrode 10, an electrode 20, and an electrolyte membrane 30. The electrode 10, the electrode 20, and the electrolyte membrane 30 may be stacked.

The electrode 10 functions as an anode. The electrode 10 may be, for example, an anode of a water electrolysis device or an anode of any other electrolysis device, such as an ammonium electrolysis device.

The electrode 20 functions as a cathode. The electrode 20 may be, for example, a cathode of a water electrolysis device or a cathode of any other electrolysis device, such as an ammonium electrolysis device.

The electrolyte membrane 30 allows protons to migrate between the electrode 10 and the electrode 20 therethrough. The electrolyte membrane 30 is provided between the electrode 10 and the electrode 20.

FIG. 2 is a schematic sectional view illustrating a structure example of the electrode 10. FIG. 2 shows an X-axis, a Y-axis orthogonal to the X-axis, and a Z-axis orthogonal to the X-axis and the Y-axis. FIG. 2 illustrates part of an X-Z cross section of the electrode 10. The Z-axis direction is a thickness direction of the electrode 10.

The electrode 10 has a current collector layer 11 and a catalyst layer 12.

An example of the current collector layer 11 is a substrate formed using a carbon material such as carbon cloth or carbon paper, or using a metal material such as a metal, such as titanium (Ti), nickel (Ni), or iron (Fe), or an alloy (for example, SUS) containing at least one of these metals. The current collector layer 11 may be a nonwoven fabric, a mesh substrate, or a porous substrate having any of these materials. Examples of the porous substrate include a porous titanium material. Having high conductivity and high durability, the porous titanium material is suitable as the current collector layer 11. Examples of the porous titanium material include a titanium mesh, a cloth made of titanium fibers, and a titanium sintered compact.

Considering substance migration, the porosity of the current collector layer 11 may be not less than 20% nor more than 95%, and is more preferably not less than 40% nor more than 90%. For example, in the case where the current collector layer 11 is a metal nonwoven fabric made of entangled metal fibers, the fiber diameter is preferably not less than 1 μm nor more than 500 μm, and considering reactivity and current-collecting capability, is more preferably not less than 1 μm nor more than 100 μm. In the case where the current collector layer 11 is a sintered particle compact, the particle diameter is preferably not less than 1 μm nor more than 500 μm, and considering reactivity and current-collecting capability, is more preferably not less than 1 μm nor more than 100 μm.

The current collector layer 11 may have a coating layer on its surface. The dense coating layer having electrical conductivity can improve the durability of the electrode 10. The coating layer is not particularly limited, but a metal material, a ceramic material such as oxide or nitride, carbon, or the like is usable. Forming a multilayer or graded structure composed of different materials in the coating layer can further enhance durability.

The catalyst layer 12 is an anode catalyst layer and is provided between the current collector layer 11 and the electrolyte membrane 30. The catalyst layer 12 is provided on the current collector layer 11, and has a surface 12a provided opposite the current collector layer 11 and a surface 12b provided opposite the surface 12a and facing the current collector layer 11. The surface 12a faces, for example, the electrolyte membrane 30.

It is possible to form the catalyst layer 12 by, for example, mixing particulate anode catalysts with first polyelectrolytes to coat the surfaces of the anode catalysts with the first polyelectrolytes. The catalyst layer 12 is not limited to the above and may have, for example, a stacked structure including a plurality of sheet layers containing the anode catalyst.

An example of the anode catalyst is an oxide of a noble metal whose main component is iridium (Ir) or ruthenium (Ru). The main component mentioned here means a component having the highest concentration among the constituent components. Examples of the oxide of the noble metal include iridium oxide and ruthenium oxide. In the case of a water electrolysis device, the anode catalyst is, for example, a material that promotes a reaction in which water is oxidized and oxygen and protons are produced. The average particle diameter of the particulate anode catalysts is, for example, not less than 1 nm nor more than 10 nm.

The first polyelectrolyte is an ionomer having proton conductivity. Examples of the first polyelectrolyte include a fluoropolymer ionomer (fluoropolymer material) such as Nafion.

FIG. 3 is a schematic sectional view illustrating a structure example of the electrode 20. FIG. 3 shows an X-axis, a Y-axis orthogonal to the X-axis, and a Z-axis orthogonal to the X-axis and the Y-axis. FIG. 3 illustrates part of an X-Z cross section of the electrode 20. The Z-axis direction is a thickness direction of the electrode 20.

The electrode 20 has a current collector layer 21 and a catalyst layer 22.

An example of the current collector layer 21 is a substrate formed using a carbon material such as carbon cloth or carbon paper, or using a metal material such as a metal, such as titanium (Ti), nickel (Ni), or iron (Fe), or an alloy (for example, SUS) containing at least one of these metals. The current collector layer 21 may also be a nonwoven fabric, a mesh substrate, or a porous substrate having any of these materials. Examples of the porous substrate include a porous titanium material. Having high electrical conductivity and high durability, the porous titanium material is suitable as the current collector layer 21. Examples of the porous titanium material include a titanium mesh, a cloth made of titanium fibers, and a titanium sintered compact.

Considering substance migration, the porosity of the current collector layer 21 may be not less than 20% nor more than 95%, and is more preferably not less than 40% nor more than 80%. For example, in the case where the current collector layer 21 is a metal nonwoven fabric made of entangled metal fibers, the fiber diameter is preferably not more than 1 μm nor more than 500 μm, and considering reactivity and current-collecting capability, is more preferably not more than 1 μm nor more than 50 μm. In the case where the current collector layer 21 is a sintered particle compact, the particle diameter is preferably not more than 1 μm nor more than 500 μm, and considering reactivity and current-collecting capability, is more preferably not less than 0.5 μm nor more than 20 μm. Still more preferably, it is not less than 0.5 μm nor more than 5 μm.

The current collector layer 21 may have a coating layer on its surface. The dense coating layer having electrical conductivity can improve the durability of the electrode 20. The coating layer is not particularly limited, but a metal material, a ceramic material such as oxide or nitride, carbon, or the like is usable. Forming a multilayer or graded structure composed of different materials in the coating layer can further enhance durability.

The catalyst layer 22 is a cathode catalyst layer and is provided between the current collector layer 21 and the electrolyte membrane 30. The catalyst layer 22 is provided on the current collector layer 21, and has a surface 22a provided opposite the current collector layer 21 and a surface 22b provided opposite the surface 22a and facing the current collector layer 21. The surface 22a faces, for example, the electrolyte membrane 30.

It is possible to form the catalyst layer 22 by, for example, mixing particulate cathode catalysts with second polyelectrolytes to coat the surfaces of the cathode catalysts with the second polyelectrolytes.

An example of the cathode catalyst contains platinum (Pt) or gold (Au) as its main component. In the case of a noble metal water electrolysis device, the cathode catalyst is, for example, a material that promotes a reaction in which protons are reduced and hydrogen is produced. The particulate cathode catalysts may be supported on other particles such as carbon particles. The average particle diameter of the particulate cathode catalysts is smaller than the average particle diameter of the other particles and is, for example, not less than 0.5 nm nor more than 5 nm.

The second polyelectrolyte is an ionomer having proton conductivity. Examples of the second polyelectrolyte include a fluoropolymer ionomer such as Nafion.

The thickness of the catalyst layer 22 is, for example, not less than 50 nm nor more than 50 μm. If it is less than 50 nm, due to the small amount of the catalyst, reaction efficiency decreases. If it exceeds 50 μm, the dispersibility of the produced hydrogen gas worsens, and a migration path becomes long, resulting in poor performance.

The dimensions and compositions of the current collector layer 21 and the catalyst layer 22 can be measured using, for example, an element mapping of a scanning electron microscope (SEM), an X-ray fluorescence analysis method (XRF), or a transmission electron microscope (TEM), a high-angle annular dark-field method (HAADF) of TEM, or an energy dispersive X-ray spectroscopy (EDX).

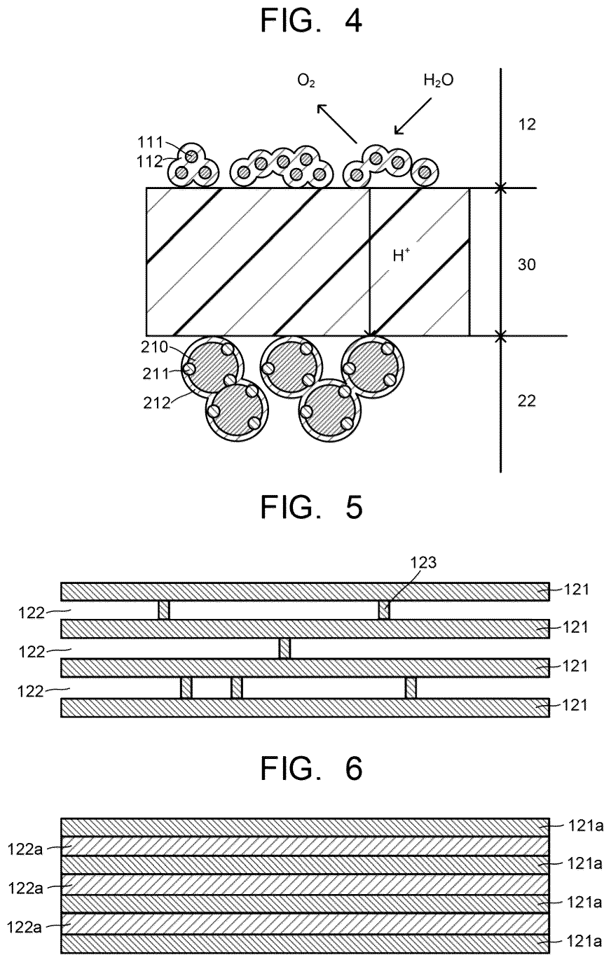

FIG. 4 is a schematic view illustrating a structure example of the electrolyte membrane 30. FIG. 4 illustrates structure examples of an interface between the electrolyte membrane 30 and the catalyst layer 12 and an interface between the electrolyte membrane and the catalyst layer 22. The electrolyte membrane 30 has, for example, a third polyelectrolyte that allows ions to migrate between the electrode 10 and the electrode 20 therethrough. The third polyelectrolyte is an ionomer having proton conductivity. Examples of the third polyelectrolyte include a fluoropolymer ionomer such as Nafion. The first polyelectrolyte, the second polyelectrolyte, and the third polyelectrolyte may be made of the same material. The electrolyte membrane 30 may be impregnated with part of the catalyst layer 12 and the catalyst layer 22.

In FIG. 4, the catalyst layer 12 has, for example, the particulate anode catalysts 111 and the first polyelectrolytes 112 covering the anode catalysts 111, and the catalyst layer 22 has, for example, support particles 210 such as carbon particles, the particulate cathode catalysts 211 supported on the surfaces of the support particles 210, and the second polyelectrolytes 212 covering the cathode catalysts 211.

One of the indices representing the performance of a proton conductor, such as the catalyst layer 12, the catalyst layer 22, and the electrolyte membrane 30, is an ion exchange equivalent weight (also called EW). The ion exchange equivalent weight is a value representing how many ions it can exchange. The ion exchange equivalent weight is represented by, for example, an ion exchange capacity per dry weight of a membrane.

It is generally known that as the ion exchange equivalent weight is lower, ion exchange ability is higher. However, too low an ion exchange equivalent weight makes the electrolyte membrane 30 prone to degradation. Therefore, in the electrochemical reaction device, too high an ion exchange equivalent weight and too low an ion exchange equivalent weight both cause performance degradation.

Further, the magnitude relationship of ion exchange equivalent weight among the catalyst layer 12, the catalyst layer 22, and the electrolyte membrane 30 has an influence on the performance of the electrochemical reaction device. What are influenced by the ion exchange equivalent weight magnitude relationship are, for example, the suppression of an increase in an initial voltage, the suppression of reversible degradation, and the suppression of irreversible degradation. To improve the performance of the electrochemical reaction device, it is required to achieve all of these in a well-balanced manner.

The initial voltage is a voltage of an electrochemical cell (cell voltage) when the electrochemical reaction device starts operating. As the ion exchange equivalent weight is lower, proton conductivity is higher, and thus the initial voltage is lower. Further, as the proton conductor is thinner, the electrical resistance of the electrolyte membrane 30 is lower and thus the initial voltage is lower.

Reversible degradation is mainly a phenomenon in which the cell voltage increases due to an increase in the resistance of the interface with the catalyst layer 12 or the catalyst layer 22 after the start of the operation of the electrochemical reaction device. After the change in the cell voltage due to reversible degradation, the cell voltage returns to the original state when the operation is stopped.

Irreversible degradation is a phenomenon in which the cell voltage fluctuates as the polyelectrolyte deteriorates due to the operation. As the ion exchange equivalent weight is lower, the structure of the polyelectrolyte is more prone to breaking, and thus this phenomenon becomes more pronounced. Irreversible degradation is more likely to occur in the catalyst layer 12, where radicals are easily generated, than in the catalyst layer 22 in the case of continuous operation, though depending on the operation condition.

In this embodiment, the ion exchange equivalent weights are adjusted so that the ion exchange equivalent weight of the electrolyte membrane 30 becomes equal to or higher than the ion exchange equivalent weight of the catalyst layer 22, and the ion exchange equivalent weight of the catalyst layer 12 becomes higher than the ion exchange equivalent weight of the catalyst layer 22 and equal to or higher than the ion exchange equivalent weight of the electrolyte membrane 30. This achieves all of the low initial voltage, the high effect of suppressing reversible degradation, and the high effect of suppressing irreversible degradation.

In the case where the catalyst layer 12, the catalyst layer 22, and the electrolyte membrane 30 contain the polyelectrolytes, the ion exchange equivalent weights of the respective members are represented by the ion exchange equivalent weights of the polyelectrolytes contained in the members.

The ion exchange equivalent weight of the catalyst layer 12 is preferably higher than or equal to the ion exchange equivalent weight of the electrolyte membrane 30. This allows the protons produced in the catalyst layer 12 to smoothly migrate through the electrolyte membrane 30, making it possible to suppress a decrease in the initial voltage.

The ion exchange equivalent weight of the catalyst layer 12 is preferably not lower than 800 g/mol nor higher than 1300 g/mol. This suppresses the irreversible degradation of the catalyst layer 12 caused by radicals, ensuring that ion conduction is kept high in the catalyst layer 12 over a long period.

The ion exchange equivalent weight of the catalyst layer 22 is preferably not lower than 400 g/mol nor higher than 700 g/mol. During operation, since the catalyst layer 22 is less prone to radical generation than the catalyst layer 12 and the electrolyte membrane 30, it is less likely to undergo irreversible degradation. Therefore, lowering its ion exchange equivalent weight makes it possible to make the initial voltage low and obtain long-term stability owing to the high proton conductivity.

The ion exchange equivalent weight of the electrolyte membrane 30 is preferably not lower than 600 g/mol nor higher than 1000 g/mol. If the electrolyte membrane 30 is thicker than the catalyst layer 12 and the catalyst layer 22, the migration distance of protons becomes long and, in the case where it is in direct contact with the catalyst layer 12 where radicals are easily generated, setting its ion exchange equivalent weight to a value equal to or slightly lower than that of the catalyst layer 12 allows the protons from the catalyst layer 12 to smoothly migrate, making it possible to improve the performance of the electrochemical reaction device and maintain the long-term stability. Further, setting the ion exchange equivalent weight of the electrolyte membrane 30 higher than or equal to the ion exchange equivalent weight of the catalyst layer 22 also has the effect of allowing the protons to smoothly migrate through the interface between the electrolyte membrane 30 and the catalyst layer 22, making it possible to suppress reversible degradation.

The thickness of the catalyst layer 12 is preferably 5 μm or less. The lower limit of the thickness of the catalyst layer 12 is not particularly limited, but the thickness is, for example, 0.1 μm or more. This shortens the migration distance of the protons, making it possible to suppress an increase in the initial voltage. Further, since the resistance does not easily become high even if the ion exchange equivalent weight increases, it is possible to suppress an increase in the initial voltage.

The thickness of the catalyst layer 22 is preferably not less than 5 μm nor more than 100 μm. This allows the use of a material with a high bulk density, such as platinum-loaded carbon having a large catalyst surface area, making it possible to reduce the amount of the catalyst in the catalyst layer 22. Further, in the case where a pressure difference is provided between the catalyst layer 22 and the catalyst layer 12 in the production of hydrogen under high pressures, it is possible to obtain the effect of inhibiting the peeling of the catalyst layer 22, owing to a pressure absorption effect based on the large thickness of the catalyst layer 22.

The thickness of the electrolyte membrane 30 is preferably 10 μm or more. The upper limit of the thickness of the electrolyte membrane 30 is not particularly limited, but the thickness is, for example, 200 μm or less. This ensures a lower cell voltage and can inhibit a short circuit due to the breakage of the electrolyte membrane 30.

In this embodiment, the thicknesses of the layers are adjusted such that the thickness of the catalyst layer 22 becomes more than the thickness of the catalyst layer 12 and equal to or less than the thickness of the electrolyte membrane 30. This can achieve a low initial voltage and a high effect of suppressing degradation.

The catalyst layer 12 may be one that contains none of the polyelectrolytes. In the case where the catalyst layer 12 has a stacked structure of a plurality of sheet layers, the ion exchange equivalent weight of the catalyst layer 12 can be considered the highest. This is because the anode catalyst such as iridium oxide or ruthenium oxide, which is usable for the sheet layers, itself is a solid superacid having proton conductivity on the surface of the catalyst and is an oxide allowing the protons to migrate therethrough, and simply by the migration of the protons on its surface, the migration velocity is made slower than when the protons migrate three-dimensionally as in a polyelectrolyte. FIG. 5 is a schematic view illustrating a sectional structure of part of the stacked structure. The catalyst layer 12 has a stacked structure including sheet layers 121 and gap layers 122. FIG. 5 illustrates the plurality of sheet layers 121 and the plurality of gap layers 122. The plurality of sheet layers 121 and the plurality of gap layers 122 are alternately stacked on the current collector layer 11. Note that the end portions of the plurality of sheet layers 121 in terms of at least one direction out of the X-axis direction and the Y-axis direction may be partly connected. This can inhibit the deformation of the catalyst layer 12 caused by the pressure in the stacking direction. Further, between the plurality of sheet layers 121, the catalyst layer 12 may have catalyst pillars 123 connecting these. This can inhibit the peeling of the sheet layers 121.

The sheet layers 121 and the catalyst pillars 123 have the anode catalysts. The number of the sheet layers 121 stacked is not particularly limited, but is, for example, not less than five nor more than fifty. The thickness of each of the sheet layers 121 is, for example, not less than 10 nm nor more than 40 nm.

The gap layers 122 are each provided between the plurality of sheet layers 121. The gap layers 122 each form a space between the plurality of sheet layers 121. The average thickness of the gap layers 122 is, for example, not less than 1 nm nor more than 100 nm.

The average thickness of the catalyst layer 12 is, for example, not less than 100 nm nor more than 1000 nm. If it is less than 100 nm, reaction efficiency decreases due to the small catalyst amount. If it exceeds 1000 nm, dispersibility worsens, and the performance of supplying water to the catalyst layer and discharging oxygen gas worsens, resulting in poor performance.

The dimensions and compositions of the current collector layer 11, the catalyst layer 12, the sheet layers 121, and the gap layers 122 can be measured using, for example, element mapping of a scanning electron microscope (SEM), an X-ray fluorescence analysis method (XRF), or a transmission electron microscope (TEM), a high-angle annular dark-field method (HAADF) of TEM, or an energy dispersive X-ray spectroscopy (EDX).

FIG. 6 is a schematic sectional view for explaining an example of a method of forming the catalyst layer 12. As illustrated in FIG. 6, it is possible to form the catalyst layer 12 by forming precursor layers 121a of the sheet layers 121 and pore-forming material layers 122a alternately on the current collector layer 11 using sputtering, and thereafter removing the pore-forming material layers 122a while leaving the precursor layers 121a. This method is capable of controlling the film thickness of the sheet layers 121 and the pore-forming material layers 122a on a nanometer order, and it also easily controls the compositions and oxidation state, making it possible to improve the degree of design freedom of the sheet layers 121.

The precursor layers 121a have the anode catalysts. In the case where the precursor layers 121a are amorphous, their crystal structure may be oriented by heat treatment. In the case where a catalyst containing iridium oxide is used, reactive sputtering in which oxygen gas is added into the chamber of a sputtering apparatus is suitable.

The pore-forming material layers 122a each contain a pore-forming material. An example of the pore-forming material contains at least one non-noble metal or its oxide. Examples of the non-noble metal include iron (Fe), cobalt (Co), nickel (Ni), manganese (Mn), aluminum (Al), zinc (Zn), tantalum (Ta), tungsten (W), hafnium (Hf), silicon (Si), molybdenum (Mo), titanium (Ti), zirconium (Zr), niobium (Nb), vanadium (V), chromium (Cr), tin (Sn), and strontium (Sr). Further, it is possible to remove the pore-forming material layers 122a while leaving the sheet layers 121, by, for example, selective etching using a chemical agent such as acid or alkali. Further, heat treatment may be performed to promote the dissolution of the pore-forming material layers 122a.

The pore-forming material may also be contained in the precursor layers 121a. For example, by performing sputtering using a mixed sputtering target containing a raw material of the precursor layers 121a and a raw material of the pore-forming material, it is possible to form the precursor layers 121a containing the pore-forming material. Consequently, the pore-forming material in the precursor layers 121a is also removed by the selective etching, making it possible to make the sheet layers 121 porous. This can increase the surface area of the sheet layers 121.

### Second Embodiment

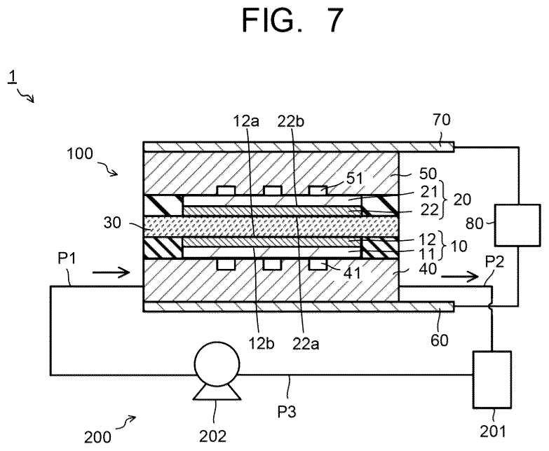

In this embodiment, an example of a hydrogen production device having the electrochemical cell of the first embodiment will be described. FIG. 7 is a schematic view illustrating a configuration example of the hydrogen production device. The hydrogen production device 1 illustrated in FIG. 7 has the membrane electrode assembly 100 and an anode solution supply system 200.

The electrode 10 is provided to face an anode flow channel 41 through which an anode solution flows. The electrode 10 is provided with the surface 12b of the catalyst layer 12 facing the current collector layer 11 and with the surface 12a thereof facing the electrolyte membrane 30. The anode flow channel 41 has a groove provided in the surface of a separator 40. The anode flow channel 41 has an inlet and an outlet, which are not illustrated. The inlet of the anode flow channel 41 is connected to an anode supply channel P1. The outlet of the anode flow channel 41 is connected to an anode discharge channel P2. The shape of the anode flow channel 41 is not particularly limited, but may be, for example, a serpentine shape along the surface of the separator 40. The separator 40 is made of, for example, metal.

The electrode 20 is provided to face a cathode flow channel 51. The electrode 20 is provided with the surface 22b of the catalyst layer 22 facing the current collector layer 21 and with the surface 22a thereof facing the electrolyte membrane 30. The cathode flow channel 51 has a groove provided in the surface of a separator 50. The cathode flow channel 51 has a not-illustrated outlet. The outlet of the cathode flow channel 51 is connected to, for example, a not-illustrated product collector. The shape of the cathode flow channel 51 is not particularly limited, but may be, for example, a serpentine shape along the surface of the separator 50. The separator 50 is made of, for example, metal.

The electrode 10 and the electrode 20 are electrically connected to an anode current collector 60 and a cathode current collector 70 respectively. The anode current collector 60 and the cathode current collector 70 are electrically connected to a power supply 80 through current introduction members. The power supply 80 is not limited to a typical power supply such as a grid power supply and a battery, but may have a power source that supplies power generated using renewable energy generated by a solar cell, wind power generation, or the like. The power supply 80 may have the above-mentioned power source, a power controller that adjusts the output of the above-mentioned power source to control the voltage across the electrode 10 and the electrode 20, and so on.

The electrode 10, the electrode 20, the electrolyte membrane 30, the separator 40, the separator 50, the anode current collector 60, and the cathode current collector 70 may be stacked. This stack is also called an electrolysis cell. This stack may be sandwiched between a not-illustrated pair of support plates and further fastened with bolts or the like.

The anode solution supply system 200 has an anode solution container 201, a flow rate controller 202, and a circulation channel P3, and is configured such that the anode solution circulates in the anode flow channel 41. In the anode solution supply system 200, the anode supply channel P1 and the anode discharge channel P2 are connected through the circulation channel P3. In the middle of the anode supply channel P1, the anode discharge channel P2, or the circulation channel P3, a valve or a pump may be formed to control the pressure of each channel or the flow rate of a fluid flowing in each channel.

The anode solution container 201 has a tank storing an anode solution-containing fluid (also called an anode waste liquid) discharged from the outlet of the anode flow channel 41 through the anode discharge channel P2. The flow rate controller 202 is provided in the middle of at least one of the anode supply channel P1, the anode discharge channel P2, and the circulation channel P3 to control the flow rate of the anode solution. The anode solution is introduced into the anode flow channel 41 through the anode supply channel P1. Note that a pressure controller may be provided in the middle of at least one of the anode supply channel P1, the anode discharge channel P2, and the circulation channel P3 to control the pressure in the anode flow channel 41. The anode solution container 201 may be connected to a not-illustrated anode solution supply source so that the anode solution is replenished to the anode solution container 201 from the anode solution supply source.

The anode solution is preferably a solution containing at least water (H₂O). The anode solution may be, for example, ultrapure water.

Next, a method of controlling the electrochemical reaction device will be described. When an electrolysis by the electrochemical reaction device is performed, the anode solution is supplied to the anode flow channel 41, and the power supply 80 applies a voltage across the electrode 10 and the electrode 20 to supply a current. The anode solution is supplied to the catalyst layer 12 of the electrode 10. The passage of the current between the electrode 10 and the electrode 20 causes the following oxidation reaction near the electrode 10 and the following reduction reaction near the electrode 20. Here, a case where protons are produced through the oxidation of water, and hydrogen is produced through the reduction of the protons will be described, but other side reactions may occur. First, a reaction process in the case where protons (H⁺) are produced through the oxidation of water (H₂O) will be described. When the current is supplied from the power supply 80 between the electrode 10 and the electrode 20, the oxidation reaction of water (H₂O) occurs in the electrode 10 in contact with the anode solution. Specifically, as shown by the following formula (1), H₂O contained in the anode solution is oxidized, resulting in the production of oxygen (O₂), protons (H⁺), and electrons (e⁻). The oxygen produced in the electrode 10 is discharged to the outside of the electrode 10 through the gap layers 122. The discharged oxygen may be collected by a not-illustrated anode product collector.

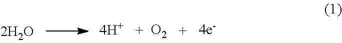

The H⁺ produced in the electrode 10 migrates through the anode solution present in the electrode 10 and through the electrolyte membrane 30 to reach the vicinity of the electrode 20. With electrons (e) based on the current supplied to the electrode 20 from the power supply 80 and H+ having migrated to the vicinity of the electrode 20, the reduction reaction of the protons occurs. Specifically, as shown by the following formula (2), as a result of the reduction of the protons, hydrogen is produced. The hydrogen produced in the electrode 20 is discharged from the outlet of the cathode flow channel 51. The discharged hydrogen may be collected by a not-illustrated cathode product collector.

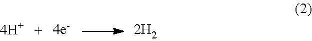

The foregoing is a description of the method of controlling the electrochemical reaction device. In the electrochemical reaction device of this embodiment, by employing the membrane electrode assembly 100, it is possible to suppress an increase in the initial voltage, reversible degradation, and irreversible degradation. This can suppress the performance degradation of the electrochemical reaction device.

### EXAMPLES

### Examples 1-5, Comparative Examples 1-11

Water electrolysis devices having the configuration illustrated in FIG. 7 were produced. In Examples 1~4 and Comparative Examples 1-11, the catalyst layer 12 was fabricated as follows. A slurry was fabricated in which powder iridium oxide and a fluoropolymer ionomer were mixed at a weight ratio of 1:0.1, and using a bar coater, this was applied and dried on the electrolyte membrane 30, which was a fluoropolymer membrane. Thereafter, the catalyst layer 22 was fabricated as follows. A slurry was fabricated in which platinum-loaded carbon having a Pt amount of 50 wt % and a fluoropolymer ionomer were mixed at a weight ratio of 1:0.5, and using a bar coater, this was applied and dried on a surface, of the electrolyte membrane 30, opposite the catalyst layer 12. Thereafter, a titanium nonwoven fabric coated with platinum was placed as the current collector layer 11 on the catalyst layer 12, and carbon paper was placed as the current collector layer 21 on the catalyst layer 22. Consequently, MEA having the electrode 10, the electrode 20, and the electrolyte membrane 30 was formed. Further, MEA was sandwiched between the separators 40, 50, which were formed of titanium plates having undergone cutting work to have channels with a depth of 1 mm at a 1 mm pitch and having been plated with gold. The anode current collector 60 and the cathode current collector 70 were formed of titanium plates plated with gold. These members were placed and sandwiched between not-illustrated support plates and were further fastened with bolts.

In Example 5, the catalyst layer 12 having the stacked structure of the sheet layers 121 and the gap layers 122 was formed as follows. Iridium and a pore-forming metal were sputter-deposited in multilayers directly onto the titanium nonwoven fabric 11, and thereafter, the pore-forming metal was dissolved with nitric acid. Thereafter, the catalyst layer 22 was fabricated as follows. A slurry was fabricated in which platinum-loaded carbon having a Pt amount of 50 wt % and a fluoropolymer ionomer were mixed at a weight ratio of 1:0.5, and using a bar coater, this was applied and dried on the electrolyte membrane 30, which was a fluoropolymer membrane. Thereafter, the electrode 10, in which the catalyst layer 12 and the titanium nonwoven fabric 11 were integrated, and the electrolyte membrane 30, which was coated with the catalyst layer 22, were arranged, and on the catalyst layer 22, carbon paper was placed as the current collector layer 21. Consequently, MEA having the electrode 10, the electrode 20, and the electrolyte membrane 30 was formed.

The thickness of the electrode 10 is 4 μm in Examples 1~4 and Comparative Examples 1-11, and is 0.8 μm in Example 5. The thicknesses of the electrode 20 and the electrolyte membrane 30 are 30 μm and 100 μm respectively in Examples 1-5 and Comparative Example 1-11. Table 1 to Table 3 show the values of the ion exchange equivalent weights (EW) of the catalyst layer 12 (anode catalyst layer), the catalyst layer 22 (cathode catalyst layer), and the electrolyte membrane 30. The unit of EW of the members shown in Table 1 to Table 3 is “g/mol”. Note that, in Example 5, the ion exchange equivalent weight of the catalyst layer 12 can be regarded as 1500 g/mol.

In the electrolysis devices of Examples 1-5 and Comparative Examples 1-11, the temperature of the electrolysis cell was set to 80° C., an electrolysis operation was continued for 167 hours under a current density of 2 A/cm² while water was supplied to the anode flow channel 41, and thereafter the current density was decreased to and kept at 0 A/cm² for one hour. This was repeated a hundred times, and the effects of suppressing an increase in the initial voltage, reversible degradation, and irreversible degradation were evaluated, and as a comprehensive evaluation of these suppression effects, total power consumption after the 16700-hour operation was evaluated. Table 1 to Table 3 show the evaluation results.

The effect of suppressing an increase in the initial voltage was evaluated based on a cell voltage measured after 24-hour operation under the 2 A/cm² current density. A case where the cell voltage at this time was 1.85 V or higher was evaluated as “x (Very Bad)”. A case where the cell voltage was equal to or higher than 1.75 and lower than 1.85 V was evaluated as “Δ (Bad)”. A case where the cell voltage was lower than 1.75 V was evaluated as “∘ (Good)”.

The effect of suppressing reversible degradation was evaluated based on a cell voltage measured after the 167-hour operation. A case where an increase in the cell voltage after the 167-hour operation was 100 mV or more with respect to the initial voltage was evaluated as “x (Very Bad)”. An increase of 10 mV or more and less than 100 mV was evaluated as “Δ (Bad)”. An increase of less than 10 mV was evaluated as “∘ (Good)”.

The effect of suppressing irreversible degradation was evaluated based on a cell voltage measured after the above-mentioned hundred-time repetitions of the electrolysis operation. A case where an increase in the cell voltage after the hundred-time repetitions was 300 mV or more with respect to the initial voltage was evaluated as “x (Very Bad)”. An increase of 100 mV or more and less than 300 mV was evaluated as “Δ (Bad)”. An increase of less than 100 mV was evaluated as “∘ (Good)”.

The comprehensive evaluation was based on cell voltage x current density cumulative value (kWh/cm²) measured every 24 hours in the above-described electrolysis operation. A cumulative value of 66 kWh/cm² was evaluated as “x (Very Bad)”. A cumulative value of 63 kWh/cm² or more and less than 66 kWh/cm² was evaluated as “Δ (Bad)”. A cumulative value of 60 kWh/cm² or more and less than 63 kWh/cm² was evaluated as “∘ (Good)”. A cumulative value of less than 60 kWh/cm² was evaluated as “⊚ (Very Good)”.

TABLE 1

| | Comparative | Comparative | Comparative | Comparative | Comparative |
|---|---|---|---|---|---|
| | example 1 | example 2 | example 3 | example 4 | example 5 |
| EW (anode catalyst layer) | 1100 | 600 | 1100 | 600 | 1300 |
| EW (electrolyte membrane) | 1100 | 600 | 600 | 1100 | 600 |
| EW (cathode catalyst layer) | 1100 | 1100 | 1100 | 1100 | 1100 |
| Initial voltage | X | Δ | Δ | X | Δ |
| Reversible degradation | ◯ | X | X | X | X |
| Irreversible degradation | ◯ | X | Δ | Δ | Δ |
| Comprehensive evaluation | Δ | X | X | X | X |

TABLE 2

| | Comparative | Comparative | Comparative | Comparative | Comparative | Comparative |
|---|---|---|---|---|---|---|
| | example 6 | example 7 | example 8 | example 9 | example 10 | example 11 |
| EW (anode catalyst layer) | 1100 | 1100 | 1300 | 600 | 800 | 1300 |
| EW (electrolyte membrane) | 1000 | 1100 | 1300 | 600 | 1100 | 1100 |
| EW (cathode catalyst layer) | 1100 | 1300 | 1300 | 600 | 1300 | 1300 |
| Initial voltage | Δ | X | X | ◯ | X | X |
| Reversible degradation | Δ | X | ◯ | ◯ | X | X |
| Irreversible degradation | Δ | ◯ | ◯ | X | X | ◯ |
| Comprehensive evaluation | Δ | X | X | X | X | X |

TABLE 3

| | Example 1 | Example 2 | Example 3 | Example 4 | Example 5 |
|---|---|---|---|---|---|
| EW (anode catalyst layer) | 1100 | 1100 | 1300 | 1100 | 1500 |
| EW (electrolyte membrane) | 600 | 1100 | 1100 | 800 | 1100 |
| EW (cathode catalyst layer) | 600 | 600 | 800 | 600 | 600 |
| Initial voltage | ◯ | Δ | Δ | ◯ | Δ |
| Reversible degradation | ◯ | ◯ | ◯ | ◯ | ◯ |
| Irreversible degradation | Δ | ◯ | ◯ | Δ | ◯ |
| Comprehensive evaluation | ⊚ | ◯ | ◯ | ⊚ | ◯ |

As shown in Table 1 to Table 3, it is seen that, in Examples 1-5, by adjusting the ion exchange equivalent weights, it is possible to suppress an increase in the initial voltage, reversible degradation, irreversible degradation, and the cumulative value of cell voltage x current density.

In Comparative Example 1, since the ion exchange equivalent weights of the anode catalyst layer, the cathode catalyst layer, and the electrolyte membrane are equal, reversible degradation caused by interfacial resistance during proton migration is difficult to occur. Further, since the ion exchange equivalent weights are on an intermediate level, irreversible degradation is also difficult to occur. On the other hand, due to the high exchange equivalent weights, a good initial voltage was not obtained, resulting in the comprehensive evaluation of Δ.

In Comparative Example 2, since the ion exchange equivalent weights of the anode catalyst layer and the electrolyte membrane are low, the initial voltage is better than in Comparative Example 1. On the other hand, since the cathode catalyst layer is higher in ion exchange equivalent weight than the electrolyte membrane, interfacial resistance during proton migration readily occurs, which is likely to cause reversible degradation. Further, since the fluoropolymer ionomer having a low ion exchange equivalent weight is used as the anode catalyst layer where radicals are readily generated, irreversible degradation accelerated, leading to the comprehensive evaluation of x.

In Comparative Example 3, as in Comparative Example 2, since the cathode catalyst layer is higher in ion exchange equivalent weight than the electrolyte membrane, interfacial resistance due to proton migration readily occurs, which is likely to cause reversible degradation. Since the ion exchange equivalent weight of the electrolyte membrane was low, though the ion exchange equivalent weight of the anode catalyst layer was on an intermediate level, the effect of suppressing irreversible degradation was evaluated as Δ. Since the ion exchange equivalent weight of the cathode layer, which was the thickest next to the electrolyte membrane, was on an intermediate level, though the ion exchange equivalent weight of the electrolyte membrane was low, the effect of suppressing an increase in the initial voltage was evaluated as Δ. As a result of these, the comprehensive evaluation was x.

In Comparative Example 4, since the ion exchange equivalent weight of the anode catalyst layer was low, but the ion exchange equivalent weight of the electrolyte membrane, which is the most susceptible to radicals next to the anode catalyst layer, was higher than in Comparative Example 1, the effect of suppressing irreversible degradation was evaluated as Δ. Further, since the ion exchange equivalent weights of the electrolyte membrane and the cathode catalyst layer were on an intermediate level, the effect of suppressing an increase in the initial voltage was evaluated as x. Since the electrolyte membrane was higher in ion exchange equivalent weight than the anode catalyst layer, the effect of suppressing reversible degradation was evaluated as x. The comprehensive evaluation was x.

In Comparative Example 5, since the ion exchange equivalent weight of the electrolyte membrane was low, though the ion exchange equivalent weight of the anode catalyst layer was high, the effect of suppressing an increase in the initial voltage was evaluated as Δ. Further, the larger ion exchange equivalent weight of the cathode catalyst layer than that of the electrolyte membrane inhibits proton migration, which is likely to cause reversible degradation, resulting in the x evaluation of the effect of suppressing reversible degradation. Since the ionomer having a high ion exchange equivalent weight was used as the anode catalyst layer, the anode catalyst layer was not prone to degradation, but since the ion exchange equivalent weight of the electrolyte membrane, which is the most susceptible to radicals next to the anode catalyst layer, was low, the effect of suppressing irreversible degradation was evaluated as Δ. The comprehensive evaluation was x.

The comprehensive evaluations for Comparative Examples 6-11, whose evaluation results also had the same tendencies as those for Comparative Examples 1-5, were or x.

In Example 1, since the ion exchange equivalent weight of the electrolyte membrane was low, though the ion exchange equivalent weight of the anode catalyst layer was on an intermediate level, the effect of suppressing irreversible degradation was evaluated as Δ. On the other hand, since the ion exchange equivalent weights satisfy the relationship of anode catalyst layer >electrolyte membrane=cathode catalyst layer, the effect of suppressing reversible degradation was evaluated as ∘. Further, since the ion exchange equivalent weight of the electrolyte membrane was low, the effect of suppressing an increase in the initial voltage was evaluated as ∘. As a result of these, the comprehensive evaluation was ⊚.

In Example 2, since the ion exchange equivalent weights of the anode catalyst layer and the electrolyte membrane were on an intermediate level, the effect of suppressing an increase in the initial voltage was evaluated as Δ, but since the ion exchange equivalent weights satisfied the relationship of anode catalyst layer=electrolyte membrane >cathode catalyst layer, the effect of suppressing reversible degradation was evaluated as ∘. Further, since the ion exchange equivalent weights of the anode catalyst layer and the electrolyte membrane were equal, the effect of suppressing irreversible degradation was also evaluated as ∘. The comprehensive evaluation was ∘.

In Example 3, since the ion exchange equivalent weight of the anode catalyst layer was high, the effect of suppressing irreversible degradation was evaluated as ∘. Further, since the ion exchange equivalent weights satisfied the relationship of anode catalyst layer >electrolyte membrane >cathode catalyst layer, the effect of suppressing reversible degradation was evaluated as ∘. On the other hand, since the ion exchange equivalent weight of the electrolyte membrane was on an intermediate level, and the ionomer having a high ion exchange equivalent weight was also used as the anode catalyst layer, the effect of suppressing an increase in the initial voltage was evaluated as Δ. The comprehensive evaluation was ∘.

In Example 4, since the electrolyte membrane had a low ion exchange equivalent weight, while the ionomer having an intermediate-level ion exchange equivalent weight was used as the anode catalyst layer, the effect of suppressing irreversible degradation was evaluated as Δ. On the other hand, since the ion exchange equivalent weights satisfied the relationship of anode catalyst layer >electrolyte membrane >cathode catalyst layer, the effect of suppressing reversible degradation was evaluated as ∘. Further, since the electrolyte membrane and the cathode catalyst layer, which were thicker than the anode catalyst, had low ion exchange equivalent weights, the effect of suppressing an increase in the initial voltage was evaluated as ∘. The comprehensive evaluation was ⊚.

In Example 5, the sputtered catalyst layer of iridium oxide, which does not use a fluoropolymer ionomer, is used as the anode catalyst layer. The ion exchange equivalent weight of the anode catalyst layer at this time was considered high, and a polyelectrolyte was not present. Accordingly, irreversible degradation caused by the influence of radicals was difficult to occur, and thus the effect of suppressing irreversible degradation was evaluated as ∘. Further, since the ion exchange equivalent weights satisfy the relationship of anode catalyst layer >electrolyte membrane >cathode catalyst layer, reversible degradation is difficult to occur, and thus the effect of suppressing reversible degradation was evaluated as ∘. Since the electrolyte membrane having an intermediate-level ion exchange equivalent weight was used, the effect of suppressing an increase in the initial voltage was evaluated as Δ. The comprehensive evaluation was ∘.

It should be noted that the configurations of the above-described embodiments are applicable in combination and can be partly replaced. While certain embodiments have been described here, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalent weights are intended to cover such forms or modifications as would fall within the scope and spirit of the inventions.

The above-described embodiments can be summarized into the following clauses.

### (Clause 1)

A membrane electrode assembly including:
an anode having an anode catalyst layer;
a cathode having a cathode catalyst layer; and
an electrolyte membrane provided between the anode and the cathode, wherein:
an ion exchange equivalent weight of the electrolyte membrane is equal to or higher than an ion exchange equivalent weight of the cathode catalyst layer; and
an ion exchange equivalent weight of the anode catalyst layer is higher than the ion exchange equivalent weight of the cathode catalyst layer and is equal to or higher than the ion exchange equivalent weight of the electrolyte membrane.

### (Clause 2)

The membrane electrode assembly according to clause 1, wherein the ion exchange equivalent weight of the anode catalyst layer is higher than the ion exchange equivalent weight of the electrolyte membrane.

### (Clause 3)

The membrane electrode assembly according to clause 1 or clause 2, wherein:
the anode catalyst layer has
an anode catalyst, and
a first polyelectrolyte provided on a surface of the anode catalyst;
the cathode catalyst layer has
a cathode catalyst, and
a second polyelectrolyte provided on a surface of the cathode catalyst; and
the electrolyte membrane has a third polyelectrolyte.

### (Clause 4)

The membrane electrode assembly according to any one of clause 1 to clause 3, wherein:
the anode catalyst layer has a thickness of 5 μm or less;
the cathode catalyst layer has a thickness of 5 μm or more; and
the electrolyte membrane has a thickness of 10 μm or more.

### (Clause 5)

The membrane electrode assembly according to any one of clause 1 to clause 4, wherein:
the ion exchange equivalent weight of the anode catalyst layer is not lower than 800 g/mol nor higher than 1300 g/mol;
the ion exchange equivalent weight of the cathode catalyst layer is not lower than 400 g/mol nor higher than 700 g/mol; and
the ion exchange equivalent weight of the electrolyte membrane is not lower than 600 g/mol nor higher than 1000 g/mol.

### (Clause 6)

The membrane electrode assembly according to clause 3, wherein the first polyelectrolyte, the second polyelectrolyte, and the third polyelectrolyte are each a fluoropolymer material.

### (Clause 7)

The membrane electrode assembly according to clause 3 or clause 6, wherein:
the anode catalyst contains iridium; and
the cathode catalyst contains platinum.

### (Clause 8)

An electrochemical reaction device including the membrane electrode assembly according to any one of clause 1 to clause 7.

What is claimed is:

1. A membrane electrode assembly comprising:
an anode having an anode catalyst layer;
a cathode having a cathode catalyst layer; and
an electrolyte membrane provided between the anode and the cathode, wherein:
an ion exchange equivalent weight of the electrolyte membrane is equal to or higher than an ion exchange equivalent weight of the cathode catalyst layer; and
an ion exchange equivalent weight of the anode catalyst layer is higher than the ion exchange equivalent weight of the cathode catalyst layer and is equal to or higher than the ion exchange equivalent weight of the electrolyte membrane.

2. The membrane electrode assembly according to claim 1, wherein the ion exchange equivalent weight of the anode catalyst layer is higher than the ion exchange equivalent weight of the electrolyte membrane.

3. The membrane electrode assembly according to claim 1, wherein:
the anode catalyst layer has
an anode catalyst, and
a first polyelectrolyte provided on a surface of the anode catalyst;
the cathode catalyst layer has
a cathode catalyst, and
a second polyelectrolyte provided on a surface of the cathode catalyst; and
the electrolyte membrane has a third polyelectrolyte.

4. The membrane electrode assembly according to claim 1, wherein:
the anode catalyst layer has a thickness of 5 μm or less;
the cathode catalyst layer has a thickness of 5 μm or more; and
the electrolyte membrane has a thickness of 10 μm or more.

5. The membrane electrode assembly according to claim 1, wherein:
the ion exchange equivalent weight of the anode catalyst layer is not lower than 800 g/mol nor higher than 1300 g/mol;
the ion exchange equivalent weight of the cathode catalyst layer is not lower than 400 g/mol nor higher than 700 g/mol; and
the ion exchange equivalent weight of the electrolyte membrane is not lower than 600 g/mol nor higher than 1000 g/mol.

6. The membrane electrode assembly according to claim 3, wherein the first polyelectrolyte, the second polyelectrolyte, and the third polyelectrolyte are each a fluoropolymer material.

7. The membrane electrode assembly according to claim 3, wherein:
the anode catalyst contains iridium; and
the cathode catalyst contains platinum.

8. An electrochemical reaction device including the membrane electrode assembly according to claim 1.
